(19) United States
(12) Patent Application Publication
(10) Pub. No.: US 2008/0146482 A1
(43) Pub. Date: Jun. 19, 2008

(54) Liquid laundry detergent having improved brightener stability

(75) Inventors: Eva Schneiderman, Mason, OH (US); Fredric Barton Rea, Lawrenceburg, IN (US); Pauline Cuc Vu, Florence, KY (US); Michael Rene Weaver, Cincinnati, OH (US); Donna Jane Wiedemann, West Harrison, IN (US); David Kent Rollins, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/634,764

(22) Filed: Dec. 6, 2006

(51) Int. Cl. C11D 3/42

(52) U.S. Cl. 510/293; 510/325; 510/337; 510/299; 510/340; 510/339

(57) ABSTRACT

Liquid laundry compositions containing having improved brightener stability, which contain from about 6% to about 20%, by weight of the laundry composition, of a surfactant component that includes from about 1% to about 6%, by weight of the laundry composition, of a mid-branched primary alkyl sulfate surfactant having an average carbon chain length of from about 16 to about 17 and from about 0.5% to about 9%, by weight of the laundry composition, of an HLAS surfactant selected from alkyl benzene sulfonic acids, alkali metal salts of C10-16 alkyl benzene sulfonic acids, in combination with from about 0.03% to about 0.2%, by weight of the laundry composition, a water-insoluble optical brightener having a water solubility when measured at about 50° C. of from 0 to about 2 g/l; and from about 0.5% to about 4%, by weight of the laundry composition, of monethanolamine, wherein the ratio of HLAS surfactant to a total amount of surfactant, on a weight basis, is from about 1:14 to about 5:7; the ratio of monoethanolamine to the total amount of surfactant is from about 1:15 to about 1:4; and the ratio of water insoluble brightener to the total amount of surfactant is lower than about 1:100. Methods of improving the deposition of a water-insoluble brightener onto fabrics using such compositions.

### FIELD OF THE INVENTION

The present invention relates to laundry detergent compositions with improved stability of water insoluble brightener that contain mid-branched primary alkyl sulfate.

### BACKGROUND OF THE INVENTION

Numerous laundry treatment compositions are available for use by consumers in the washing of clothing and other fabrics in traditional washing machines. However, consumers still struggle to remove some residues and/or stains from fabric items. Detergent manufacturers can often increase the amount of surfactants in their detergent products in order to provide improved cleaning.

However, an increase in surfactants results in additional cost for the overall product which must either be absorbed by the manufacturer or passed on to the consumer, both undesirable results. Increase surfactant levels also increases the potential for damage to or fading of fabrics which is extremely undesirable to consumers. In addition, due to a more recent dramatic increase in costs for petrochemical-derived products such as certain surfactants, detergent manufacturers have faced even greater difficulty in formulating cost-effective laundry detergent compositions with improved cleaning.

Optical brighteners have been known in the art for use in laundry detergent compositions and when deposited on fabrics, provide a visual benefit. These are desirable to include in liquid laundry detergent compositions as they may make white clothing look whiter and/or make colored clothing appear brighter, and therefore, newer. Optical brighteners which are more insoluble in water are preferable for deposition on fabrics. However, such brighteners are characteristically more difficult to stably formulate in aqueous liquid laundry compositions.

When used in sufficient amounts, monoethanolamine (MEA) is known to act as a counterion to optical brighteners and thus provide better brightener stability. However, the level of MEA in a laundry detergent product must be limited to some degree in order to avoid malodor problems in the finished product and residual malodor depositing on fabrics laundered with the detergent.

Mid-branched primary alkyl sulfate surfactants having an average carbon chain length of from about 14 to about 17 (“MBAS surfactants”) are known for providing good cleaning properties. MBAS surfactants exhibit good cleaning properties when used as a main chassis surfactant as well as when used in a lower level in combination with other surfactants or in low surfactant detergent compositions. However it has been found that when included at lower absolute levels in a Heavy Duty Liquid (HDL) laundry detergent composition, the MBAS surfactants with a carbon chain length of about 16 to 17 (also referred to as “HSAS surfactants”) generally provide better cleaning than those of other chain-lengths. However, use of the HSAS surfactants typically results in an increase in the hydrophobicity of the surfactant system. Without being bound by theory, it has been surprising found that this increased hydrophobicity of the surfactant system appears to lead to decreased brightener stability, even when combined with water insoluble brighteners. One of ordinary skill would have contrarily expected better solubility of the water insoluble brightener with increased surfactant system hydrophobicity.

Therefore, the need still exists for a liquid laundry detergent composition with good cleaning that contains water insoluble optical brightener, and still includes the ability to reduce overall surfactant levels by the use of mid-branched primary alkyl sulfate surfactants having an average carbon chain length of from about 16 to about 17.

### SUMMARY OF THE INVENTION

It has now surprisingly been found that laundry detergents, especially heavy duty liquid laundry detergents that contain mid-branched primary alkyl sulfate surfactants having an average carbon chain length of from about 16 to about 17 and optical brighteners can be formulated to include HLAS surfactants in order to provide improved water insoluble brightener stability, good fabric cleaning, and cost-effectiveness. Compositions according to the present invention are described in further detail below.

Thus the invention encompasses a liquid laundry detergent composition wherein the laundry composition contains an optical brightener and has improved brightener stability. Such liquid laundry compositions contain from about 6% to about 20%, by weight of the laundry composition, of a surfactant component from about 0.03% to about 0.2%, by weight of the laundry composition, of the optical brightener wherein the optical brightener is a water-insoluble optical brightener having a water solubility when measured at about 50° C. of from 0 to about 2 g/l; and from about 0.5% to about 4%, by weight of the laundry composition, of monethanolamine. The surfactant component contains from about 1% to about 6%, by weight of the laundry composition, of a mid-branched primary alkyl sulfate surfactant having an average carbon chain length of from about 16 to about 17 and from about 0.5% to about 9%, by weight of the laundry composition, of an HLAS surfactant selected from alkyl benzene sulfonic acids, alkali metal salts of C10-16 alkyl benzene sulfonic acids. Further, the ratio of HLAS surfactant to a total amount of surfactant, on a weight basis, is from about 1:14 to about 5:7; the ratio of monoethanolamine to the total amount of surfactant is from about 1:15 to about 1:4; and the ratio of water insoluble brightener to the total amount of surfactant is lower than about 1:100.

In further embodiments, the invention is directed to such compositions wherein the surfactant component contains from about 1% to about 9%, by weight of the laundry composition, of the HLAS surfactant.

In further embodiments, the invention is directed to such compositions wherein the ratio of HLAS surfactant to surfactant component, on a weight basis, is from about 1:14 to about 1:2.

In further embodiments, the invention is directed to such compositions wherein the laundry composition contains from about 1.2% to about 4%, by weight of the composition of monoethanolamine and wherein the ratio of monoethanolamine to the total amount of surfactant is from about 1:12 to about 1:6.

In further embodiments, the invention is directed to such compositions wherein the ratio of water insoluble brightener to the total amount of surfactant is lower than about 1:130.

In further embodiments, the invention is directed to such compositions wherein the water-insoluble optical brightener has water solubility measured at about 50° C. of from about 0.2 g/l to about 2 g/l.

In further embodiments, the invention is directed to such compositions wherein the water-insoluble optical brightener is selected from disodium 4,4′-bis{[4-anilino-6morpholino-s-triazin-2-yl]amino}-2,2′-stilbenedisulfonate; disodium 4,4′-bis-(2-sulfostryl)biphenyl; disodium 4,4′-bis[{4,6-di-anilino-s-triazin-2-yl]-amino}-2,2′ stilbene disulfonate; and mixtures thereof.

In further embodiments, the invention is directed to such compositions wherein the laundry composition comprises from about 0.03% to about 0.2%, by weight of the laundry composition, of the optical brightener.

In further embodiments, the invention is directed to such compositions wherein the HLAS surfactant is selected from C11-14 alkyl benzene sulfonic acids and mixtures thereof.

In further embodiments, the invention is directed to such compositions wherein the HLAS surfactant is selected from linear alkyl benzene sulfonates and mixtures thereof.

In further embodiments, the invention is directed to such compositions wherein the HLAS surfactant is selected from sodium linear alkyl benzene sulfonates and mixtures thereof.

In further embodiments, the invention is directed to such compositions wherein the composition contains from about from about 0.5% to about 9%, by weight of the laundry composition, of an HLAS surfactant selected from alkyl benzene sulfonic acids, alkali metal salts of C10-16 alkyl benzene sulfonic acids.

In further embodiments, the invention is directed to such compositions wherein the surfactant component further includes an additional surfactant selected from anionic surfactants, nonionic surfactants, methyl ester sulfonates, amine oxide, other cationic surfactants, and mixtures thereof.

In further embodiments, the invention is directed to such compositions wherein the additional surfactant is selected from AES, nonionic surfactants, and mixtures thereof.

In further embodiments, the invention is directed to such compositions wherein the surfactant component further includes from about 0.2% to about 3% of an additional surfactant selected from nonionic surfactants.

In further embodiments, the invention is directed to such compositions wherein the laundry composition further includes from about 0.5% to about 1.5%, by weight of the laundry composition, of borax.

In further embodiments, the invention is directed to such compositions wherein the laundry composition has a pH of from about 8.0 to about 8.7.

In further embodiments, the invention is directed to such compositions wherein the laundry composition is transparent or translucent.

In further embodiments, the invention is directed to such compositions wherein the laundry composition is stored in a container, wherein said container is transparent or translucent.

In further embodiments, the invention is directed to such compositions wherein the laundry composition further comprises a laundry adjunct ingredient selected from builders, additional brighteners, dye transfer inhibitors, structurants, chelants, polyacrylate polymers, dispersing agents, dyes, perfumes, processing aids, bleaching compounds, solvents, enzymes, microcapsules, beads, soil release polymers, and mixtures thereof.

Another aspect of the invention provides liquid laundry detergent compositions containing an optical brightener and having improved brightener stability, wherein the composition contains: from about 6% to about 20%, by weight of the laundry composition, of a surfactant component, from about 0.03% to about 0.2%, by weight of the laundry composition, of the optical brightener wherein the optical brightener is a water-insoluble optical brightener having a water solubility when measured at about 50° C. of from 0 to about 2 g/l and the optical brightener is selected from disodium 4,4′-bis{[4-anilino-6morpholino-s-triazin-2-yl]amino}-2,2′-stilbenedisulfonate; disodium 4,4′-bis-(2-sulfostryl)biphenyl; disodium 4,4′-bis[{4,6-di-anilino-s-triazin-2-yl]-amino}-2,2′ stilbene disulfonate; and mixtures thereof; and from about 0.5% to about 4%, by weight of the laundry composition, of monethanolamine. The surfactant component contains from about 1% to about 6%, by weight of the laundry composition, of a mid-branched primary alkyl sulfate surfactant having an average carbon chain length of from about 16 to about 17, and from about 0.5% to about 9%, by weight of the laundry composition, of an HLAS surfactant selected from alkyl benzene sulfonic acids, alkali metal salts of C10-16 alkyl benzene sulfonic acids. The composition further includes a ratio of HLAS surfactant to a total amount of surfactant component, on a weight basis, of from about 1:14 to about 5:7; a ratio of monoethanolamine to total surfactant of from about 1:15 to about 1:4, and a ratio of water insoluble brightener to total surfactant of lower than 1:100.

Another aspect of the invention provides a method of improving the deposition of a water-insoluble brightener onto fabrics, wherein said method comprises at least the step of:

A) formulating a liquid laundry detergent containing:
a) from about 6% to about 20%, by weight of the laundry composition, of a surfactant component comprising;
   i) from about 1% to about 6%, by weight of the laundry composition, of a mid-branched primary alkyl sulfate surfactant having an average carbon chain length of from about 16 to about 17;
   ii) from about 0.5% to about 9%, by weight of the laundry composition, of an HLAS surfactant selected from alkyl benzene sulfonic acids, alkali metal salts of C10-16 alkyl benzene sulfonic acids;
b) from about 0.03% to about 0.2%, by weight of the laundry composition, of the optical brightener wherein the optical brightener is a water-insoluble optical brightener having a water solubility when measured at about 50° C. of from 0 to about 2 g/l; and
c) from about 0.5% to about 4%, by weight of the laundry composition, of monethanolamine;
   wherein the ratio of HLAS surfactant to a total amount of surfactant component, on a weight basis, is from about 1:14 to about 5:7; the ratio of monoethanolamine to the total amount of surfactant is from about 1:15 to about 1:4; and the ratio of water insoluble brightener to the total amount of surfactant is lower than about 1:100.

B) adding the liquid laundry composition to a wash water of a standard washing machine;

C) adding fabrics to the wash water; and

D) running a wash cycle.

The compositions and methods of the present invention are advantageous in providing improved water insoluble brightener stability, while maintaining good cleaning and a cost-effective surfactant system. Additional objects and advantages will be apparent in view of the detailed description of the invention.

These and other features, aspects, and advantages of the present invention will become evident to those skilled in the art from a reading of the present disclosure.

### DETAILED DESCRIPTION OF THE INVENTION

The laundry detergent compositions of the present invention are generally in liquid form. In one embodiment, the compositions are liquid in form and comprise heavy duty liquid compositions.

All percentages and ratios used herein are by weight of the total composition and all measurements made are at 25° C., unless otherwise designated.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages, parts and ratios are based upon the total weight of the liquid laundry detergent compositions of the present invention, unless otherwise specified. All such weights as they pertain to listed ingredients are based on the active level and therefore, do not include carriers or by-products that may be included in commercially available materials, unless otherwise specified.

It has now been found that a liquid laundry composition containing from about 6% to about 20%, by weight of the laundry composition, of a surfactant component that contains from about 1% to about 6%, by weight of the laundry composition, of a mid-branched primary alkyl sulfate surfactant having an average carbon chain length of from about 16 to about 17 and from about 0.5% to about 9%, by weight of the laundry composition, of an HLAS surfactant selected from alkyl benzene sulfonic acids, alkali metal salts of C10-16 alkyl benzene sulfonic acids can be combined with from about 0.03% to about 0.2%, by weight of the laundry composition, of a water insoluble optical brightener having a water solubility when measured at about 50° C. of from 0 to about 2 g/l; and from about 0.5% to about 4%, by weight of the laundry composition, of monethanolamine to have improved brightener stability and good cleaning properties while retaining the cost-effectiveness of a lower surfactant system wherein the composition also exhibits, a ratio of HLAS surfactant to a total amount of surfactant component, on a weight basis, of from about 1:14 to about 5:7; a ratio of MEA to total surfactant of from about 1:15 to about 1:4, and a ratio of water insoluble brightener to total surfactant that is lower than 1:100.

Without being limited by theory, it is thought that the presence of the surfactants having aromatic ring such as those of HLAS and MLAS surfactants, increases the compatibility of the water insoluble brightener with the aqueous phase and with the assistance of minimal levels of the brightener counterion, MEA, counteracts the brightener instability effects of the HSAS surfactant. This allows for a desirable liquid laundry detergent composition that includes water-insoluble brightener (having good deposition on fabrics) with the good cleaning properties (even at cost-effective low overall surfactant levels) of HSAS surfactants, without undesirable malodor of higher levels of MEA.

The compositions herein may also include a wide variety of other ingredients. While the specification concludes with the claims particularly pointing and distinctly claiming the invention, it is believed that the present invention will be better understood from the following description.

### Liquid Laundry Detergent Composition

As used herein, “liquid laundry detergent composition” refers to compositions which are useful for the cleaning of textiles, fabrics, clothing articles, and the like. Such laundry compositions are of a viscosity such that they are pourable or squeezable at room temperature.

### Water-Insoluble Optical Brightener

Optical brighteners are well known in the art for use in laundry detergent compositions and when deposited on fabrics to provide a visual benefit as they may make white clothing look whiter and/or make colored clothing appear brighter, and therefore, newer. As used herein, “water-insoluble optical brightener” refers to those optical brighteners having a water solubility when measured at about 50° C. of from 0 to about 2 g/l. In one embodiment, the optical brightener has water solubility when measured at about 50° C. of from about 0.2 to about 2 g/l. The laundry detergent compositions of the present invention comprise from about 0.03% to about 0.2%, by weight of the laundry composition, of the water-insoluble brightener.

The laundry compositions of the present invention include a ratio of water insoluble brightener to surfactant component that is lower than about 1:100, alternatively the ratio of water insoluble brightener to surfactant component is lower than about 1:130.

Examples of water-insoluble brighteners useful herein include disodium 4,4′-bis{[4-anilino-6morpholino-s-triazin-2-yl]amino}-2,2′-stilbenedisulfonate (commercially available under the tradename TINOPAL AMS-GX from Ciba-Geigy or under the name of BLANKOPHOR DML from Miles); disodium 4,4′-bis-(2-sulfostryl)biphenyl (commercially available under the tradename of TINOPHAL CBS from Ciba-Geigy); disodium 4,4′-bis[{4,6-di-anilino-s-triazin-2-yl]-amino}-2,2′ stilbene disulfonate (commercially available under the tradename of TINOPHAL TAS from Ciba Geigy),

### Surfactant Component

The laundry compositions of the present invention contain from about 6% to about 20%, by weight of the laundry composition, of a surfactant component. The surfactant component contains HSAS surfactant, HLAS surfactant and may contain other additional surfactants.

As used herein, “HLAS surfactant” refers to alkyl benzene sulfonic acids and alkali metal salts of C10-16 alkyl benzene sulfonic acids, preferably C11-14 alkyl benzene sulfonic acids. The alkali group can be linear and such linear alkyl benzene sulfonates are known as “LAS”. Alternatively the alkali group can be branched as described in U.S. Pat. No. 6,593,285; U.S. Pat. No. 6,596,680, U.S. Pat. No. 6,306,817, and U.S. Pat. No. 6,589,927. Such surfactants are known in the art as branched alkyl benzene sulfonic acids. Alkyl benzene sulfonates, and particularly LAS, are well known in the art. Such surfactants and their preparation are described for example in U.S. Pat. Nos. 2,220,099 and 2,477,383. An example of an HLAS surfactant is sodium linear alkyl benzene sulfonate, commonly referenced as “NaLAS.”

In one embodiment, the composition contains from about 0.5% to about 9%, by weight of the laundry composition, of HLAS and the ratio of HLAS surfactant to a total amount of surfactant component, on a weight basis, is from about 1:14 to about 5:7. In one embodiment, the ratio of HLAS surfactant to a total amount of surfactant component is from about 1:14 to about 1:2. As used herein, “HLAS surfactant” should be read to include mixtures of HLAS surfactants

As used herein, “HSAS surfactant” refers to the class of mid-chain branched primary alkyl sulfate surfactants having an average carbon chain length of from about 16 to about 17. In one embodiment the surfactant component contains 50% or less, by weight of the surfactant component, of HSAS surfactant. In one embodiment, the composition contains from about 1% to about 6%, by weight of the laundry composition, of HSAS surfactant. As used herein, “HSAS surfactant” should be read to also include mixtures of HSAS surfactants.

The laundry compositions of the present invention comprise mid-chain branched primary alkyl sulfate surfactants having the general formula

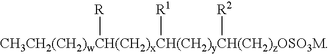

Generally, the surfactant component will contain a mixture of at least two mid-chain branched primary alkyl sulfate surfactants. In one embodiment, the surfactant component will also contain a number of other surfactant materials and similar by-products that are present due to the production procedures of such materials. This would be understood by one of ordinary skill in the area of mid-branched primary alkyl sulfate surfactants.

The mid chain branched primary alkyl sulfate surfactant mixtures of the present invention comprise molecules having a linear primary alkyl sulfate chain backbone (i.e., the longest linear carbon chain which includes the sulfated carbon atom). These alkyl chain backbones comprise from about 6 to about 16 carbon atoms, alternatively from about 13 to about 15 carbon atoms; and further the molecules comprise a branched primary alkyl moiety having at least a total of about 14, but not more than about 17, carbon atoms. In addition, the mid-chain branched primary alkyl sulfate surfactant mixture has an average total number of carbon atoms for the branched primary alkyl moieties within the range from about 16 to about 17. Thus, the present invention mixtures comprise at least one branched primary alkyl sulfate surfactant having a longest linear carbon chain of not less than 14 carbon atoms or more than 16 carbon atoms.

For example, a C16 total carbon primary alkyl sulfate surfactant having 14 carbon atoms in the backbone must have 1 and 2, branching units (i.e., R, R¹ and/or R³). Whereby total number of carbon atoms in the molecule is from about 16 to about 17. In this example, the C16 total carbon requirement may be satisfied equally by having, for example, one ethyl branching unit or two methyl branching units.

R, R¹, and R² are each independently selected from hydrogen and C₁-C₃ alkyl (alternatively from hydrogen or C₁-C₂ alkyl, alternatively from hydrogen or methyl, and in one embodiment, are methyl groups), provided R, R¹, and R² are not all hydrogen. Further, when z is 1, at least R or R¹ is not hydrogen.

Although for the purposes of the present invention laundry compositions the above formula does not include molecules wherein the units R, R¹, and R² are all hydrogen (i.e., linear non-branched primary alkyl sulfate surfactants), it is to be recognized that the present invention compositions may still further comprise some amount of linear, non-branched primary alkyl sulfate surfactant. Further, this linear non-branched primary alkyl sulfate surfactant may be present as the result of the process used to manufacture the mid chain branched primary alkyl sulfate surfactant mixture having the requisite one or more mid-chain branched primary alkyl sulfate surfactants according to the present invention, or for purposes of formulating detergent compositions some amount of linear non-branched primary alkyl sulfate may be admixed into the final product formulation.

Further it is to be similarly recognized that non-sulfated mid-chain branched alcohol may comprise some amount of the present invention compositions. Such materials may be present as the result of incomplete sulfation of the alcohol used to prepare the mid chain branched primary alkyl sulfate surfactant, or these alcohols may be separately added to the present invention detergent compositions along with a mid-chain branched alkyl sulfate surfactant according to the present invention.

M is hydrogen or a salt forming cation depending upon the method of synthesis. Examples of salt forming cations are lithium, sodium, potassium, calcium, magnesium, quaternary alkyl amines having the formula

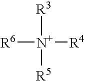

wherein R³, R⁴, R⁵ and R⁶ are independently hydrogen, C₁-C₂₂ alkylene, C₄-C₂₂ branched alkylene, C₁-C₆ alkanol, C₁-C₂₂ alkenylene, C₄-C₂₂ branched alkenylene, and mixtures thereof. Preferred cations are ammonium (R³, R⁴, R⁵ and R⁶ equal hydrogen), sodium, potassium, mono-, di-, and trialkanol ammonium, and mixtures thereof. The monoalkanol ammonium compounds of the present invention have R³ equal to C₁-C₆ alkanol, R⁴, R⁵ and R⁶ equal to hydrogen; dialkanol ammonium compounds of the present invention have R³ and R⁴ equal to C₁-C₆ alkanol, R⁵ and R⁶ equal to hydrogen; trialkanol ammonium compounds of the present invention have R³, R⁴ and R⁵ equal to C₁-C₆ alkanol, R⁶ equal to hydrogen. Preferred alkanol ammonium salts of the present invention are the mono-, di- and tri-quaternary ammonium compounds having the formulas:

H₃N⁺CH₂CH₂OH, H₂N⁺(CH₂CH₂OH)₂, HN⁺(CH₂CH₂OH)₃.

Preferred M is sodium, potassium and the C₂ alkanol ammonium salts listed above; most preferred is sodium.

Further regarding the above formula, w is an integer from 0 to 7; x is an integer from 0 to 7; y is an integer from 0 to 7; z is an integer of at least 1; and w+x+y+z is an integer from 1 to 11, alternatively from 7 to 10.

Certain points of branching (i.e., the location along the chain of the R, R¹, and/or R² moieties in the above formula) are preferred over other points of branching along the backbone of the surfactant. The formula below illustrates the mid-chain branching range (i.e., where points of branching occur), preferred mid-chain branching range, and more preferred mid-chain branching range for mono-methyl substituted linear alkyl sulfates of the present invention.

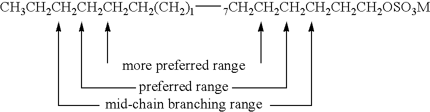

It should be noted that for the mono-methyl substituted surfactants these ranges exclude the two terminal carbon atoms of the chain and the two carbon atoms immediately adjacent to the sulfate group. Mid branched primary alkyl sulfate surfactants comprising two or more of R, R¹, or R², alkyl branching at the 2-carbon atom are within the scope of the present invention. Surfactants having chains longer than ethyl (i.e. C₃ alkyl substitutents) on the 2-carbon atom, however, are less preferred.

The formula below illustrates the mid-chain branching range, preferred mid-chain branching range, and more preferred mid-chain branching range for di-methyl substituted linear alkyl sulfates of the present invention.

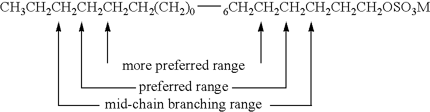

When di-alkyl substituted primary alkyl sulfates are combined with mono-substituted mid-chain branched primary alkyl sulfate surfactants, the di-alkyl substituted primary alkyl sulfates having one methyl substitution on the 2-carbon position and another methyl substitution in the preferred range as indicated above, are within the present invention.

In one embodiment, the surfactant component of the present invention includes at least 0.001%, alternatively at least 1% by weight of the surfactant component, of one or more mid-branched primary alkyl sulfate surfactants having the formula:

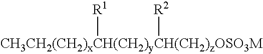

wherein the total number of carbon atoms, including branching, is from 16 to 17, R¹ and R² are each independently hydrogen or C₁-C₃ alkyl; M is a water soluble cation; x is from 0 to 7; y is from 0 to 7; z is at least 2; and x+y+z is from 2 to 10; provided R¹ and R² are not both hydrogen. Alternatively, in one embodiment the laundry compositions of the present invention contain at least 1%, by weight of the surfactant component, of one or more mid-chain branched primary alkyl sulfate surfactants wherein x+y is equal to 9 or 10 and z is 2.

In one embodiment, the mid-branched primary alkyl sulfate surfactant has the formula:

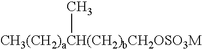

wherein: a and b are integers and a+b is 12 or 13, a is an integer from 2 to 11, b is an integer from 1 to 10 and M is selected from sodium, potassium, ammonium and substituted ammonium. More preferred embodiments of such compounds include an alkyl sulfate compound of said formula wherein M is selected from sodium, potassium and ammonium.

In one embodiment, mid-chain branched primary alkyl sulfate compounds have the formula:

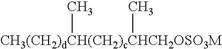

wherein:
d and e are integers and d+e is 10 or 11; and wherein further
when d+e=10, d is an integer from 2 to 9 and e is an integer from 1 to 8;
when d+e=11, d is an integer from 2 to 10 and e is an integer from 1 to 9;
and M is selected from sodium, potassium, ammonium and substituted ammonium, more preferably sodium, potassium and ammonium, most preferably sodium.

In one embodiment, mono-methyl branched primary alkyl sulfate surfactants are selected from the group consisting of: 3-methyl pentadecanol sulfate, 4-methyl pentadecanol sulfate, 5-methyl pentadecanol sulfate, 6-methyl pentadecanol sulfate, 7-methyl pentadecanol sulfate, 8-methyl pentadecanol sulfate, 9-methyl pentadecanol sulfate, 10-methyl pentadecanol sulfate, 11-methyl pentadecanol sulfate, 12-methyl pentadecanol sulfate, 13-methyl pentadecanol sulfate, 3-methyl hexadecanol sulfate, 4-methyl hexadecanol sulfate, 5-methyl hexadecanol sulfate, 6-methyl hexadecanol sulfate, 7-methyl hexadecanol sulfate, 8-methyl hexadecanol sulfate, 9-methyl hexadecanol sulfate, 10-methyl hexadecanol sulfate, 11-methyl hexadecanol sulfate, 12-methyl hexadecanol sulfate, 13-methyl hexadecanol sulfate, 14-methyl hexadecanol sulfate, and mixtures thereof.

In one embodiment, di-methyl branched primary alkyl sulfate surfactants are selected from the group consisting of: 2,3-methyl tetradecanol sulfate, 2,4-methyl tetradecanol sulfate, 2,5-methyl tetradecanol sulfate, 2,6-methyl tetradecanol sulfate, 2,7-methyl tetradecanol sulfate, 2,8-methyl tetradecanol sulfate, 2,9-methyl tetradecanol sulfate, 2,10-methyl tetradecanol sulfate, 2,11-methyl tetradecanol sulfate, 2,12-methyl tetradecanol sulfate, 2,3-methyl pentadecanol sulfate, 2,4-methyl pentadecanol sulfate, 2,5-methyl pentadecanol sulfate, 2,6-methyl pentadecanol sulfate, 2,7-methyl pentadecanol sulfate, 2,8-methyl pentadecanol sulfate, 2,9-methyl pentadecanol sulfate, 2,10-methyl pentadecanol sulfate, 2,11-methyl pentadecanol sulfate, 2,12-methyl pentadecanol sulfate, 2,13-methyl pentadecanol sulfate, and mixtures thereof.

The following mid-branched primary alkyl sulfate surfactants comprising 16 carbon atoms and having one branching unit are examples of branched surfactants useful in the laundry compositions of the present invention:

5-methylpentadecylsulfate having the formula:

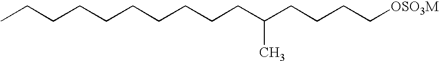

6-methylpentadecylsulfate having the formula

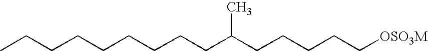

7-methylpentadecylsulfate having the formula

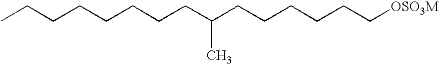

8-methylpentadecylsulfate having the formula

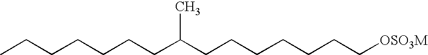

9-methylpentadecylsulfate having the formula

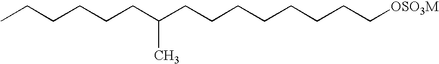

10-methylpentadecylsulfate having the formula

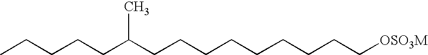

wherein M is preferably sodium.

The following branched primary alkyl sulfates comprising 17 carbon atoms and having two branching units are examples of branched surfactants useful in the laundry compositions of the present invention:

2,5-dimethylpentadecylsulfate having the formula:

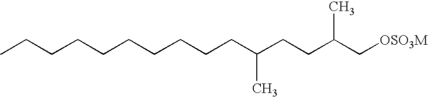

2,6-dimethylpentadecylsulfate having the formula

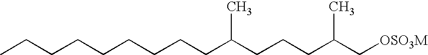

2,7-dimethylpentadecylsulfate having the formula

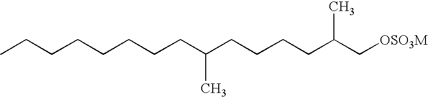

2,8-dimethylpentadecylsulfate having the formula

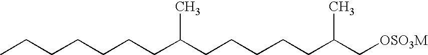

2,9-dimethylpentadecylsulfate having the formula

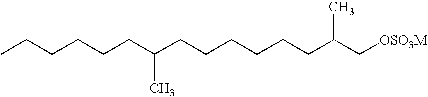

2,10-dimethylpentadecylsulfate having the formula

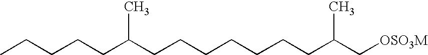

wherein M is preferably sodium.

### Additional Surfactant

The composition of the present invention may further comprise from about 0.5% to about 9%, by weight of the composition, of HLAS surfactant and at least about 2%, by weight of the composition, of an additional surfactant selected from alkyl alkoxy sulfate surfactants. The compositions of the present invention may further comprise from about 0.2-3% of alkyl alkoxy surfactants, and mixtures thereof.

In one embodiment, the surfactant component includes from about 0.2% to about 3%, by weight of the laundry composition, alternatively from about 0.2% to about 2%, of an additional surfactant selected from nonionic surfactants.

a) Alkyl Alkoxy Sulfate Surfactant

The additional surfactant may include at least 2%, by weight of the composition, of an alkyl alkoxy sulfate surfactant. The alkyl ethoxy sulfate surfactants useful herein include water soluble salts and/or acids of the formula RO(A)ₘSO₃M wherein R is an unsubstituted C₁₀-C₂₄ alkyl or hydroxyalkyl group having a C₁₀-C₂₄ alkyl component, alternatively a C₁₂-C₁₈ alkyl or hydroxyalkyl, alternatively a C₁₂-C₁₅ alkyl or hydroxyalkyl. A is an ethoxy or propoxy unit, m is greater than zero, typically between about 0.5 and about 6, alternatively between about 0.5 and about 3, and M is H or a cation which can be, for example, a metal cation (e.g., sodium, potassium, lithium, calcium, magnesium, etc.), ammonium and/or substituted-ammonium cation. Alkyl ethoxylated sulfates as well as alkyl propoxylated sulfates are useful herein. Examples of substituted ammonium cations include ethanol-, triethanol-, methyl-, dimethyl, trimethyl-ammonium cations and quaternary ammonium cations such as tetramethyl-ammonium and dimethyl piperidinium cations and those derived from alkylamines such as ethylamine, diethylamine, triethylamine, mixtures thereof, and the like. Alkyl alkoxylated sulfate surfactants useful herein include C₁₂-C₁₅ alkyl polyethoxylate (1.0) sulfate (C₁₂-C₁₅E(1.0)M); C₁₂-C₁₅ alkyl polyethoxylate (2.25) sulfate (C₁₂-C₁₅E(2.25)M); C₁₂-C₁₅ alkyl polyethoxylate (3.0) sulfate (C₁₂-C₁₅E(3.0)M); C₁₂-C₁₅ alkyl polyethoxylate (4.0) sulfate (C₁₂-C₁₅E(4.0)M), wherein M is conveniently selected from sodium and potassium; and mixtures thereof.

b) Alkyl Alkoxy Surfactant

The additional surfactant may include from about 0.2% to about 3%, by weight of the composition, of a nonionic surfactant that is an alkyl alkoxy surfactant.

Examples of alkyl alkoxy surfactants useful herein (typically at levels from about 0.2% to about 3%, by weight of the composition) include the alkoxylated alcohols (AE's) and alkyl phenols, polyhydroxy fatty acid amides (PFAA's), alkyl polyglycosides (APG's), C₁₀-C₁₈ glycerol ethers, and mixtures thereof.

More specifically, the condensation products of primary and secondary aliphatic alcohols with from about 1 to about 25 moles of ethylene oxide (AE) are suitable for use herein as an alkyl alkoxy surfactant. The alkyl chain of the aliphatic alcohol can either be straight or branched, primary or secondary, and generally contains from about 8 to about 22 carbon atoms. In one embodiment, the alkyl alkoxy surfactant is selected from the condensation products of alcohols having an alkyl group containing from about 8 to about 20 carbon atoms, more preferably from about 10 to about 18 carbon atoms, with from about 1 to about 10 moles, preferably 2 to 7, most preferably 2 to 5, of ethylene oxide per mole of alcohol. In one embodiment, the alkyl alkoxy surfactants are the C₉-C₁₅ primary alcohol ethoxylates containing 3-12 moles of ethylene oxide per mole of alcohol, particularly the C₁₂-C₁₅ primary alcohols containing 5-10 moles of ethylene oxide per mole of alcohol.

Examples of commercially available surfactants of this type include: Tergitol™ 15-S-9 (the condensation product of C₁₁-C₁₅ linear alcohol with 9 moles ethylene oxide) and Tergitol™ 24-L-6 NMW (the condensation product of C₁₂-C₁₄ primary alcohol with 6 moles ethylene oxide with a narrow molecular weight distribution), both marketed by Union Carbide Corporation; Neodol™ 45-9 (the condensation product of C₁₄-C₁₅ linear alcohol with 9 moles of ethylene oxide), Neodol™ 23-3 (the condensation product of C₁₂-C₁₃ linear alcohol with 3 moles of ethylene oxide), Neodol™ 45-7 (the condensation product of C₁₄-C₁₅ linear alcohol with 7 moles of ethylene oxide) and Neodol™ 45-5 (the condensation product of C₁₄-C₁₅ linear alcohol with 5 moles of ethylene oxide) marketed by Shell Chemical Company; Kyro™ EOB (the condensation product of C₁₃-C₁₅ alcohol with 9 moles ethylene oxide), marketed by The Procter & Gamble Company; and Genapol LA O3O or O5O (the condensation product of C₁₂-C₁₄ alcohol with 3 or 5 moles of ethylene oxide) marketed by Hoechst. Condensates with propylene oxide and butylene oxides may also be used.

### Monethanolamine

The laundry compositions of the present invention include from about 0.5% to about 4%, by weight of the laundry composition, of monethanolamine (“MEA”). In one embodiment, the ratio of MEA to total surfactant, on a weight basis, is from about 1:15 to about 1:4, alternatively is from about 1:12 to about 1:6.

Other alkanolamines can be used as alternatives to MEA. Suitable alkanolamine such as diethanolamine and triethanolamine and mixtures of thereof with one another and MEA. The preferred level of alkanolamines and mixtures of thereof range from about 0.5% to about 4.0%. In preferred embodiments of the invention the alkanolamine is in salt form, e.g., having been used to neutralize the acid form of a surfactant.

### Borax

The laundry compositions of the present invention may further contain from about 0.5% to about 1.5%, by weight of the laundry composition, of borax. Without being limited by theory, it is believed that the inclusion of this level of borax will sufficient enzyme stability.

pH

The liquid laundry detergent compositions of the present invention may have a pH of from about 8.0 to about 8.7.

### Transparent/Translucent

The liquid laundry detergent compositions of the present invention may be formulated so as to be transparent or translucent or may be formulated to be opaque, or to have any degree of opacity or transparency desired. The liquid laundry detergent compositions of the present invention may be packaged in a container/bottle having any degree of transparency or opacity desired. The liquid laundry detergent compositions of the present invention may be stored in a container/bottle, wherein said container/bottle is transparent or translucent.

As used herein, a transparent or translucent composition has about 50% transmittance or greater of light using 1 cm cuvette at wavelength of 410-800 nanometers.

A bottle or container for transporting and holding the liquid laundry detergents of the present invention may have a transmittance of more or less than 25%, alternatively more than 30%, alternatively more than 40%, alternatively more than 50% in the visible part of the spectrum (approx. 410-800 nm).

As used herein, a transparent bottle has light transmittance of greater than 25% at wavelength of about 410-800 nm.

Bottle materials with may be used to form bottles to contain the liquid laundry detergents of the present invention include; polypropylene (PP), polyethylene (PE), polycarbonate (PC), polyamides (PA) and/or polyethylene terephthalate (PETE), polyvinylchloride (PVC); and polystyrene (PS).

For purposes of the transmittance herein, as long as one wavelength in the visible light range has greater than 25% transmittance, the container or bottle is considered to be transparent/translucent.

Containers or bottles for transporting or holding the liquid detergent compositions of the present invention may be of any form or size suitable for storing and packaging liquids for household use. For example, the container may have any size but usually the container will have a maximal capacity of 0.05 to 15 L, preferably, 0.1 to 5 L, more preferably from 0.2 to 2.5 L. Preferably, the container is suitable for easy handling. For example the container may have handle or a part with such dimensions to allow easy lifting or carrying the container with one hand. The container preferably has a means suitable for pouring the liquid detergent composition and means for reclosing the container. The pouring means may be of any size of form but, preferably will be wide enough for convenient dosing the liquid detergent composition. The closing means may be of any form or size but usually will be screwed or clicked on the container to close the container. The closing means may be cap which can be detached from the container. Alternatively, the cap can still be attached to the container, whether the container is open or closed. The closing means may also be incorporated in the container.

In order to select the transmittance of the container/bottle and/or composition, it is possible to utilize such adjunct ingredients such as dyes, opacifiers, UV absorbents and/or combinations thereof.

### Laundry Adjunct Ingredients

The liquid laundry detergent compositions of the present invention may contain one or more laundry adjunct ingredients. Examples of laundry adjunct ingredients useful herein include builders (for example, citric acid), additional brighteners, dye transfer inhibitors, structurants, chelants, polyacrylate polymers, dispersing agents, dyes, perfumes, processing aids, bleaching compounds, solvents, enzymes, microcapsules, beads, soil release polymers, and mixtures thereof.

Other optional components include detersive enzymes, other than borax enzyme stabilizers (such as polyols, glycerol, propandiol, diethylene glycol, etc), builders, chelants, polymers, suds suppressors, soil suspending agents, soil release agents, pH adjusting agents, smectite clays, dye transfer inhibiting agents, other fabric care benefit agents, perfumes coloring agents, and aqueous liquid carrier. The various optional detergent composition ingredients, if present in the compositions herein, should be utilized at concentrations conventionally employed to bring about their desired contribution to the composition or the laundering operation. Frequently, the total amount of such optional detergent composition ingredients can range from about 0.01% to about 50%, more preferably from about 0.01% to about 40%, and preferably from about 0.1% to about 30% by weight of the composition.

Examples of enzymes useful herein include; hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidases, chondroitinases, laccases, amylases, or mixtures thereof. Other types of enzymes may also be included. Enzymes useful herein may be of any suitable origin, such as vegetable, animal, bacterial, fungal and yeast origin. Suitable enzymes are commercially available from a number of sources, including Genecor and Novozymes.

### Methods of Use

The compositions of the present invention may be used in laundry methods to improve the deposition of water-insoluble brightener onto fabrics.

Such methods may include the steps of:

A) formulating the liquid laundry detergent composition such that it contains;
a) from about 6% to about 20%, by weight of the laundry composition, of a surfactant component comprising;
   i) from about 1% to about 6%, by weight of the laundry composition, of a mid-branched primary alkyl sulfate surfactant having an average carbon chain length of from about 16 to about 17;
   ii) from about 0.5% to about 9%, by weight of the laundry composition, of an HLAS surfactant selected from alkyl benzene sulfonic acids, alkali metal salts of C10-16 alkyl benzene sulfonic acids;

b) from about 0.03% to about 0.2%, by weight of the laundry composition, of the optical brightener wherein the optical brightener is a water-insoluble optical brightener having a water solubility when measured at about 50° C. of from 0 to about 2 g/l; and

c) from about 0.5% to about 4%, by weight of the laundry composition, of monethanolaamine;

wherein the ratio of HLAS surfactant to a total amount of surfactant component, on a weight basis, is from about 1:14 to about 5:7, alternatively from about 1:14 to about 1:2; the ratio of MEA to total surfactant is from about 1:15 to about 1:4, alternatively from about 1:12 to about 1:6; the ratio of water insoluble brightener to total surfactant is lower than 1:100, alternatively lower than 1:130
B) adding the liquid laundry composition to a wash water of a standard washing machine;
C) adding fabrics to the wash water; and
D) running a wash cycle.

### EXAMPLES 1-2

### Heavy Duty Liquid Laundry Detergent Compositions

| Ingredient (assuming 100% | | |
|---|---|---|
| activity) | Example 1 | Example 2 |
| AES | 9 | 5 |
| HSAS | 3 | 1.5 |
| LAS | 2 | 0.9 |
| NI 23-9 | 0.5 | 0.5 |
| Additional Surfactants | 0-4 | 0-2 |
| Water-Insoluble Brightener | 0.1 | 0.04 |
| Monoethanolamine | 1.35 | 0.85 |
| Builders and chelants | 1-5 | 0.5-2 |
| Detersive Enzymes* | 0-4 | 0-2 |
| Borax | 0.5-1.5 | 0.5-1.2 |
| Other enzyme stabilizers | 0.1-10 | 0.1-6 |
| Polymers | 0-3 | 0-3 |
| buffering agents and viscosity | 0-3 | 0-3 |
| modifiers | | |

*expressed as percentage amount of raw material available from supplier, including inactive ingredients.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry composition comprising an optical brightener and having improved brightener stability, wherein the composition comprises:
a) from about 6% to about 20%, by weight of the laundry composition, of a surfactant component comprising;
i) from about 1% to about 6%, by weight of the laundry composition, of a mid-branched primary alkyl sulfate surfactant having an average carbon chain length of from about 16 to about 17;
ii) from about 0.5% to about 9%, by weight of the laundry composition, of an HLAS surfactant selected from alkyl benzene sulfonic acids, alkali metal salts of C10-16 alkyl benzene sulfonic acids;
b) from about 0.03% to about 0.2%, by weight of the laundry composition, of the optical brightener wherein the optical brightener is a water-insoluble optical brightener having a water solubility when measured at about 50° C. of from 0 to about 2 g/l; and
c) from about 0.5% to about 4%, by weight of the laundry composition, of monethanolamine;
wherein the ratio of HLAS surfactant to a total amount of surfactant, on a weight basis, is from about 1:14 to about 5:7; the ratio of monoethanolamine to the total amount of surfactant is from about 1:15 to about 1:4; and the ratio of water insoluble brightener to the total amount of surfactant is lower than about 1:100.

2. A liquid laundry detergent composition according to claim 1 wherein the surfactant component comprises from about 1% to about 9%, by weight of the laundry composition, of the HLAS surfactant.

3. A liquid laundry detergent composition according to claim 1 wherein the ratio of HLAS surfactant to surfactant component, on a weight basis, is from about 1:14 to about 1:2.

4. A liquid laundry detergent composition according to claim 1 wherein the laundry composition comprises from about 1.2% to about 4%, by weight of the composition of monoethanolamine and wherein the ratio of monoethanolamine to the total amount of surfactant is from about 1:12 to about 1:6.

5. A liquid laundry detergent composition according to claim 1 wherein the ratio of water insoluble brightener to the total amount of surfactant is lower than about 1:130.

6. A liquid laundry detergent composition according to claim 1 wherein the water-insoluble optical brightener has water solubility measured at about 50° C. of from about 0.2 g/l to about 2 g/l.

7. A liquid laundry detergent composition according to claim 6 wherein the water-insoluble optical brightener is selected from disodium 4,4′-bis{[4-anilino-6morpholino-s-triazin-2-yl]amino}-2,2′-stilbenedisulfonate; disodium 4,4′-bis-(2-sulfostryl)biphenyl; disodium 4,4′-bis[{4,6-di-anilino-s-triazin-2-yl]-amino}-2,2′ stilbene disulfonate; and mixtures thereof.

8. A liquid laundry detergent composition according to claim 1 wherein the laundry composition comprises from about 0.03% to about 0.2%, by weight of the laundry composition, of the optical brightener.

9. A liquid laundry detergent composition according to claim 1 wherein the HLAS surfactant is selected from C11-14 alkyl benzene sulfonic acids and mixtures thereof.

10. A liquid laundry detergent composition according to claim 9 wherein the HLAS surfactant is selected from linear alkyl benzene sulfonates and mixtures thereof.

11. A liquid laundry detergent composition according to claim 10 wherein the HLAS surfactant is selected from sodium linear alkyl benzene sulfonates and mixtures thereof.

12. A liquid laundry detergent composition according to claim 1 wherein the composition comprises from about from about 0.5% to about 9%, by weight of the laundry composition, of an HLAS surfactant selected from alkyl benzene sulfonic acids, alkali metal salts of C10-16 alkyl benzene sulfonic acids

13. A liquid laundry detergent composition according to claim 1 wherein the surfactant component further comprises an additional surfactant selected from anionic surfactants, nonionic surfactants, methyl ester sulfonates, amine oxide, other cationic surfactants, and mixtures thereof.

14. A liquid laundry detergent composition according to claim 11 wherein the additional surfactant is selected from AES, nonionic surfactants, and mixtures thereof.

15. A liquid laundry detergent composition according to claim 1 wherein the surfactant component further comprises from about 0.2% to about 3% of an additional surfactant selected from nonionic surfactants.

16. A liquid laundry detergent composition according to claim 1, wherein the laundry composition further comprises from about 0.5% to about 1.5%, by weight of the laundry composition, of borax.

17. A liquid laundry detergent composition according to claim 1, wherein the laundry composition has a pH of from about 8.0 to about 8.7.

18. A liquid laundry detergent composition according to claim 1, wherein the laundry composition is transparent or translucent.

19. A liquid laundry detergent composition according to claim 1, wherein the laundry composition is stored in a container, wherein said container is transparent or translucent.

20. A liquid laundry detergent composition according to claim 1, wherein the laundry composition further comprises a laundry adjunct ingredient selected from builders, additional brighteners, dye transfer inhibitors, structurants, chelants, polyacrylate polymers, dispersing agents, dyes, perfumes, processing aids, bleaching compounds, solvents, enzymes, microcapsules, beads, soil release polymers, and mixtures thereof.

21. A liquid laundry composition comprising an optical brightener and having improved brightener stability, wherein the composition comprises:
a) from about 6% to about 20%, by weight of the laundry composition, of a surfactant component comprising;
i) from about 1% to about 6%, by weight of the laundry composition, of a mid-branched primary alkyl sulfate surfactant having an average carbon chain length of from about 16 to about 17;
ii) from about 0.5% to about 9%, by weight of the laundry composition, of an HLAS surfactant selected from alkyl benzene sulfonic acids, alkali metal salts of C10-16 alkyl benzene sulfonic acids;
b) from about 0.03% to about 0.2%, by weight of the laundry composition, of the optical brightener wherein the optical brightener is a water-insoluble optical brightener having a water solubility when measured at about 50° C. of from 0 to about 2 g/l and the optical brightener is selected from disodium 4,4′-bis{[4-anilino-6morpholino-s-triazin-2-yl]amino}-2,2′-stilbenedisulfonate; disodium 4,4′-bis-(2-sulfostryl)biphenyl; disodium 4,4′-bis[{4,6-di-anilino-s-triazin-2-yl]-amino}-2,2′ stilbene disulfonate; and mixtures thereof; and
c) from about 0.5% to about 4%, by weight of the laundry composition, of monethanolamine;
wherein the ratio of HLAS surfactant to a total amount of surfactant component, on a weight basis, is from about 1:14 to about 5:7; the ratio of monoethanolamine to the total surfactant component is from about 1:15 to about 1:4, and the ratio of water insoluble brightener to the total surfactant component is lower than 1:100.

22. A method of improving the deposition of a water-insoluble brightener onto fabrics, wherein said method comprises at least the step of:
A) formulating a liquid laundry detergent comprising:
a) from about 6% to about 20%, by weight of the laundry composition, of a surfactant component comprising;
i) from about 1% to about 6%, by weight of the laundry composition, of a mid-branched primary alkyl sulfate surfactant having an average carbon chain length of from about 16 to about 17;
ii) from about 0.5% to about 9%, by weight of the laundry composition, of an HLAS surfactant selected from alkyl benzene sulfonic acids, alkali metal salts of C10-16 alkyl benzene sulfonic acids;
b) from about 0.03% to about 0.2%, by weight of the laundry composition, of the optical brightener wherein the optical brightener is a water-insoluble optical brightener having a water solubility when measured at about 50° C. of from 0 to about 2 g/l; and
c) from about 0.5% to about 4%, by weight of the laundry composition, of monethanolamine;
wherein the ratio of HLAS surfactant to a total amount of surfactant component, on a weight basis, is from about 1:14 to about 5:7; the ratio of monoethanolamine to the total surfactant component is from about 1:15 to about 1:4; and the ratio of water insoluble brightener to the total surfactant component is lower than about 1:100.
B) adding the liquid laundry composition to a wash water of a standard washing machine;
C) adding fabrics to the wash water; and
D) running a wash cycle.
